(19) United States
(12) Patent Application Publication
(10) Pub. No.: US 2019/0164061 A1
(43) Pub. Date: May 30, 2019

(54) ANALYZING PRODUCT FEATURE REQUIREMENTS USING MACHINE-BASED LEARNING AND INFORMATION RETRIEVAL

(71) Applicant: International Business Machines Corporation, Armonk, NY (US)

(72) Inventors: Andrew R Freed, Cary, NC (US); Joan W Tomlinson, Alexandria, VA (US)

(21) Appl. No.: 15/823,095

(22) Filed: Nov. 27, 2017

(51) Int. Cl. G06N 5/02; G06N 5/04; G06F 15/18; G06F 17/27; G06F 17/30; G06Q 10/06

(52) U.S. Cl. CPC G06N 5/02; G06N 5/04; G06F 15/18; G06Q 10/0635; G06F 17/2785; G06F 17/30389; G06F 17/2705

(57) ABSTRACT

A method and system that includes a data processing system comprising a processor, a memory and an artificial intelligence unit for retrieving information using a knowledge representation. The method comprising receiving, by the data processing system, a selection of a product from a computing device, parsing, by the data processing system, features of the product from product data input, generating, by the data processing system, queries from the parsed features, determining, by the data processing system, candidate answers for the queries, identifying, by the data processing system, requirements for the product based on the candidate answers, and providing, by the data processing system, the requirements to the computing device.

### BACKGROUND

The present invention generally relates to software analysis, and in particular, a method and system for retrieving information by using machine learning and natural language processing.

As an organization launches a new product, the organization may not have all the requisite knowledge as to which sets of rules and actions will apply based on each feature of the product. In effect, the organization may be blindsided by the requirements imposed to such product, and the organization may lose profit and time to remedy the issue. Thus, there is a need to anticipate the relationship between the product launch and the requirements imposed thereon.

### SUMMARY

A method, computing systems, and computer program products for retrieving information using a knowledge representation are disclosed. According to one embodiment, said method, in a data processing system comprising a processor, a memory and an artificial intelligence unit, comprising the steps of receiving, by said data processing system, a selection of a product from a computing device, parsing, by said data processing system, features of said product from product data input, generating, by said data processing system, queries from said parsed features, determining, by said data processing system, candidate answers for said queries, identifying, by said data processing system, requirements for said product based on said candidate answers, and providing, by said data processing system, said requirements to said computing device.

In one embodiment, said method may further comprise ranking, by said data processing system, said parsed features based on a relevance of said parsed features to said candidate answers. In a further embodiment, said ranking of said features of said product may further comprise assigning, by said data processing system, evidence scores to said candidate answers, synthesizing, by said data processing system, said evidence scores, and calculating, by said data processing system, a confidence score of said candidate answers based on said synthesized scores. Assigning said evidence scores to said candidate answers may comprise determining relevance of said candidate answers by analyzing language of said queries and a corpus of evidence data. Said method may also comprise applying weights to said evidence scores based on training of said data processing system with a statistical model, said weights identifying a manner to combine said evidence score to calculate said confidence score.

Said one or more products may be software, policies, contracts, transactions, computing services, or consulting services. Accordingly, said method may further comprise training said data processing system with a corpus of documents corresponding to various types of products. Said artificial intelligence unit may comprise a combination of natural language processing, semantic analysis, information retrieval, knowledge representation, automated reasoning, and machine learning technologies.

Said data processing system may be trained with words that are useful in identifying features of said product. Parsing features of said product may further comprise extracting words, numbers, and characters from source code, specific files, filenames, metadata, or content from said product data input. Generating said queries from said parsed features may further comprise expressing, by said data processing system, said parsed features as word fragments including keywords. In certain embodiments, determining candidate answers for said queries may further comprise querying, by said data processing system, a corpus of evidence data, wherein said corpus of evidence data includes information associated with system capabilities, security standards, ethical standards, corporate governance, legal liabilities, and financial standards, and constructing, by said data processing system, said candidate answers based on said querying of said corpus of evidence data. Said method may further comprise analyzing, by said data processing system, said queries, decomposing, by said data processing system, said queries into constituent parts, and querying, by said data processing system, a corpus of evidence data using said decomposed queries, and generating, by said data processing system, said candidate answers based on said querying of said corpus of evidence data.

Said requirements may include rules or actions selected from the group consisting of operating directives, guidelines, parameters, instructions, control information, benchmarks, models, system requirements, capital requirements, personnel requirements, and specifications that are associated with said parsed features.

According to one embodiment, said computing system comprises a computer processor including an artificial intelligence unit and a computer memory operatively coupled to said computer processor, said computer memory having disposed within it computer program instructions that, when executed by said processor, cause said computing system to carry out said steps of receiving a selection of a product from a computing device, parsing features of said product from product data input, generating queries from said parsed features, determining candidate answers for said queries, identifying requirements for said product based on said candidate answers, and providing said requirements to said computing device.

According to one embodiment, said computer program product comprises a computer readable storage medium having stored thereon program instructions executable by a processing device to cause said processing device to receive a selection of a product, program instructions executable by said processing device to cause said processing device to parse features of said product from product data input, program instructions executable by said processing device to cause said processing device to determine similarities between features of third-party products from a knowledge representation and said parsed features, and program instructions executable by said processing device to cause said processing device to determine risk of said product based on said similarities.

Said computer program product may further comprise program instructions executable by said processing device to cause said processing device to generate one or more queries from said parsed features, program instructions executable by said processing device to cause said processing device to query a corpus of said features of said third-party products using said one or more queries, and program instructions executable by said processing device to cause said processing device to construct candidate answers based on said querying of said corpus of said features of said third-party product features. In another embodiment, said computer program product further comprises program instructions executable by said processing device to cause said processing device to calculate a score for said risk of said product based on said similarities between said third-party product features and said parsed features. Said computer program product may also comprise program instructions executable by said processing device to cause said processing device to determine said risk based on an aggregate risk of individual third-party product features that are similar to said product. In yet another embodiment, said computer program product further comprises program instructions executable by said processing device to cause said processing device to determine said risk based on risk scores of said third-party products.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a logical block diagram of a computing system according to an embodiment of the present invention.

FIG. 4 depicts a logical block diagram of a question and answering system according to an embodiment of the present invention.

FIG. 5 depicts a flowchart of a method for retrieving information using a knowledge representation according to an embodiment of the present invention.

FIG. 6 depicts a flowchart of a method for retrieving information using a knowledge representation according to another embodiment of the present invention.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Exemplary methods, computing systems, and computer program products for retrieving information using a knowledge representation in accordance with the present invention are described with reference to the accompanying drawings. In one embodiment, a system identifies features from a given product and determines which sets of requirements (e.g., compliance, obligations, rules and actions) apply to the product based on the identified features. The features may be determined by a question answering (Q&A) computing system comprised of natural language processing (NLP), semantic analysis, information retrieval, automated reasoning, and machine learning algorithms. The system may also identify requirements that need to be in compliance (e.g., system, security, ethical, business, legal, financial, etc.) based on the features of the product. According to another embodiment, the system evaluates other products from third-parties having similar features of the given product and provides potential compliance risks based on the evaluation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third-party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third-party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

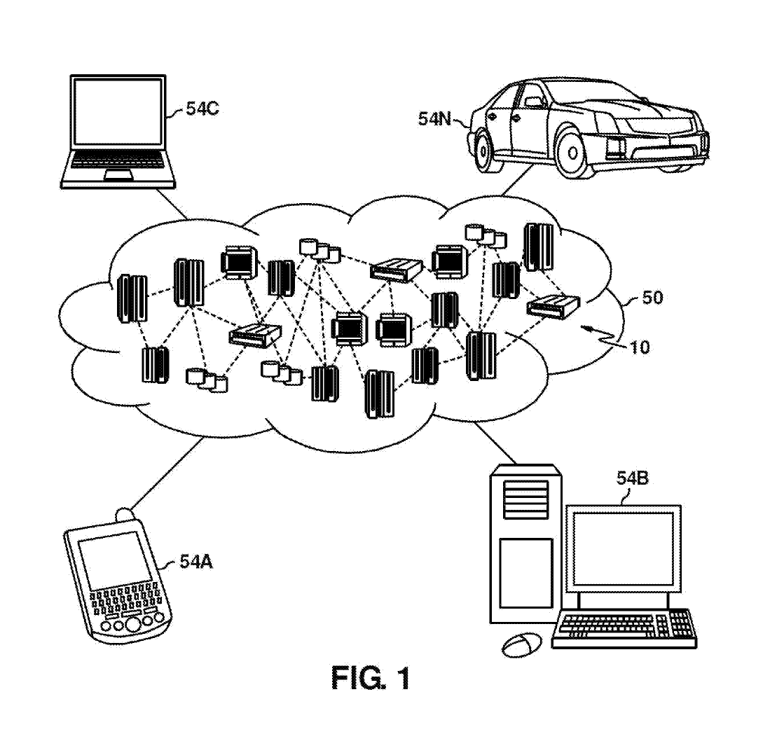

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

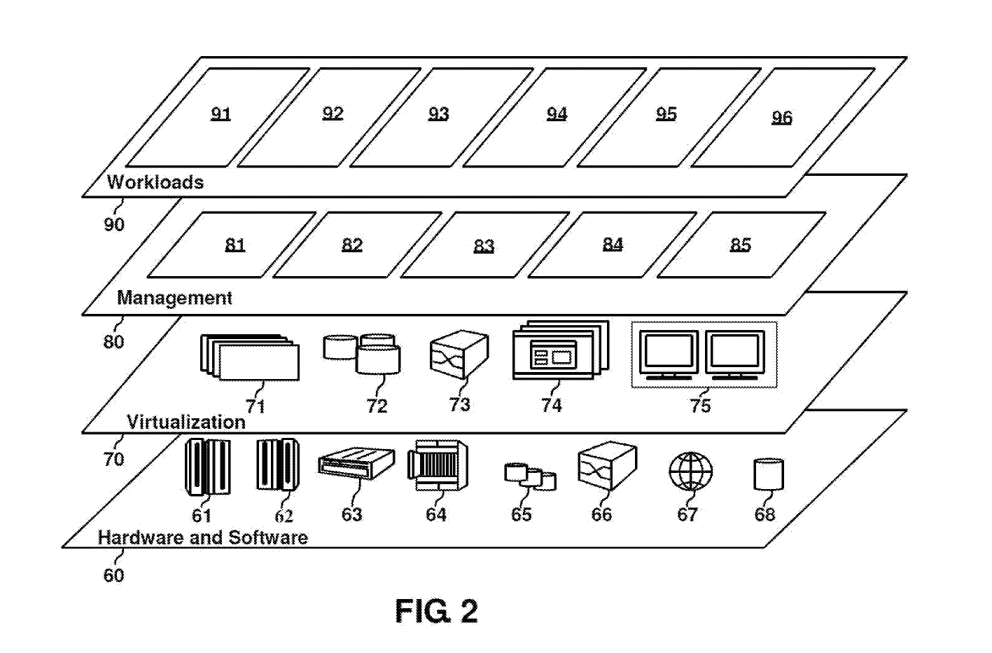

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Q&A product processing 96.

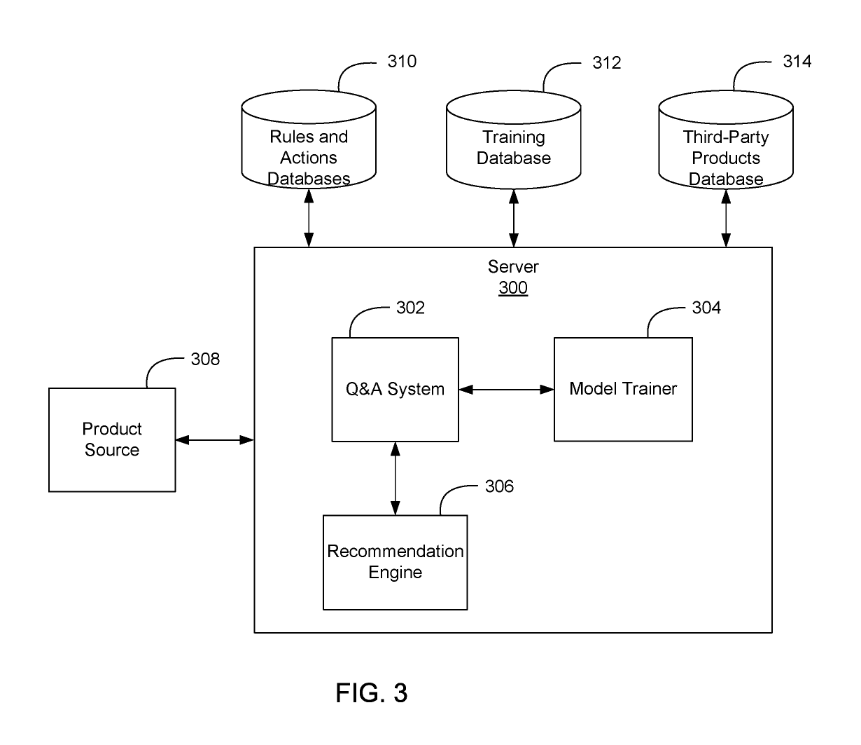

FIG. 3 presents a logical block diagram of a computing system for retrieving information using a knowledge representation according to an embodiment of the present invention. The present invention is not limited to the arrangement of devices in the exemplary system illustrated in FIG. 3, but rather are for explanation. Computing systems useful according to various embodiments of the present invention may include additional servers, routers, other devices, and peer-to-peer architectures, not shown in FIG. 3, as understood by those of skill in the art.

According to the illustrated embodiment, the system includes automated computing machinery comprising server 300 according to embodiments of the present invention. The server 300 includes at least one computer processor or “CPU” as well as random access memory (“RAM”) which is connected through a high-speed memory bus and bus adapter to the processor and to other components of the server. Stored in RAM, or a hard drive connected to the RAM, may include computer program instructions that, when executed, cause the computer to analyze product features by utilizing a Q&A system and determine which sets of requirements apply to the product based on the identified features. A product may comprise e.g., software, policies, contracts, transactions (e.g., financial), computing services (e.g., storage, cloud computing, networking), and consulting services, that may be embodied in an electronic form and extracted by Q&A system 302 for features. The requirements may include operating directives, guidelines, parameters, instructions, control information, benchmarks, models, system requirements, capital requirements, personnel requirements, or specifications that may be applicable to each product feature.

Server 300 includes a Q&A system 302. The Q&A system 302 may comprise an artificial intelligence unit including a combination of NLP, semantic analysis, information retrieval, knowledge representation, automated reasoning, and machine learning technologies (the combination hereinafter referred to as “Q&A technologies”). NLP includes understanding and deriving meaning from human natural language by computers. Semantic analysis may be used to understand a set of concepts that are related to one another. A knowledge representation may comprise a representation of information that the artificial intelligence unit can utilize to resolve a query. For example, the knowledge representation may include semantic nets, systems architecture, frames, rules, and ontologies. The information retrieval, knowledge representation, and automated reasoning technologies may receive features from the NLP to identify sources, find and generate hypotheses or candidate answers, find and score evidence, and merge and rank the hypotheses or candidate answers.

Q&A system 302 may be configured to identify features of a given product by processing product data from product source 308. The product data may include, for example, data files, source code, and product documentation (including, e.g., design documents, instructions, design, warranty, prospectus, brochures, marketing, diagrams, tables, and charts). The Q&A system 302 may parse or extract features, including text, numbers, characters, etc., from the product data by using Q&A technologies. Features parsed by the Q&A system 302 may be further analyzed to determine major features that may be used to generate, formulate, or otherwise convert the features into one or more queries for application to a knowledge base such as, rules and actions databases 310, or a knowledge representation of third-party features of products. As used herein, a “question” and “query,” and their extensions, are used interchangeably and refer to the same concept, namely request for information. Such requests may be expressed in word fragments, n-grams, an interrogative sentence, but they can also be expressed in other forms, for example, as a declarative sentence or as a set of keywords providing a description of a subject of interest.

Rules and actions databases 310 may comprise document collections used by Q&A system 302 to generate answers to the queries. The rules and actions databases 310 may include a collection of reference texts, internal organization documents and web pages, newswire reports, and online publications, etc. that define specific rules, compliances, regulations, or obligations, and actions that are required for compliance with the rules, regulations, or obligations. The rules, compliances, regulations, or obligations may be associated with aspects of, for example, system (hardware and/or software) capabilities, security standards, ethical (e.g., social media) standards, corporate governance, legal liabilities, and financial standards, etc. The rules and actions databases 310 may be referenced by Q&A system 302 to determine whether features of a product are related to any of the rules, compliances, regulations, or obligations stored in rules and actions databases 310.

Q&A system 302 may use the queries to determine and retrieve confidence-based answers to those queries by parallel hypothesis generation and evaluation of the queries. That is, the Q&A system 302 may perform differential diagnosis to generate a wide range of possible answers for the queries, and for each answer, a level of confidence may be developed by gathering, analyzing and assessing evidence data. The Q&A system 302 may find the important concepts and relations in the queries, build representations of the queries, and then through search, generate possible answers. For each possible answer, Q&A system 302 may gather, evaluate and combine different types of evidence from structured and unstructured data from one or more data sources including rules and actions databases 310, training database 312, and third-party products database 314.

According to one embodiment, machine learning techniques such as deep learning may be used by model trainer 304 to train the Q&A system 302. Deep learning may refer to a type of machine learning that attempts to model high-level abstractions in data by using multiple processing layers or multiple non-linear transformations. For example, deep learning may include the utilization of interconnected processing elements working in unison to solve specific problems such as feature extraction. The deep learning may use a family of algorithms that implement deep networks with unsupervised learning. For example, deep learning architectures such as deep neural networks, deep belief networks, and recurrent neural networks may be used to develop the NLP and knowledge representation of the Q&A system 302. A given network may comprise a system of interconnected nodes, called “neurons,” that exchange messages via connections, called “synapses” between the neurons. In deep-learning networks, each layer of nodes may train on a distinct set of features based on a previous layer's output. Successive layers may become more granular in detail to solve more complex problems the further a network is advanced. Each successive layer may aggregate and recombine features from previous layers. Multiple layers may be used to solve complex problems by breaking tasks into smaller tasks to solve sub-problems, and then gradually integrating the solutions from each layer.

Certain words, strings of characters, phrases, sentences, syntax, instructions, codes, etc., may be retrieved from rules and actions databases 310, training database 312, and third-party products database 314 by model trainer 304 to train the Q&A system 302 via machine learning. Training database 312 may include data for training specific features of Q&A system 302 such as NLP, semantic analysis, and question answering (information retrieval, knowledge representation, and automated reasoning). Third-party products database 314 may include a repository of features associated with known third-party products as well as requirements (e.g., rules, compliances, regulations, or obligations, and actions) corresponding to the third-party products or the features of the third-party products. According to an alternative embodiment, Q&A system 302 may identify third-party products having features similar to a product from third-parties and provide potential product characteristics based on the evaluation.

Q&A system 302 may further deliver a ranked list of answers in response to the queries, where each answer may be associated with an evidence profile describing an evidence score and how it was weighted by the Q&A system 302. The product features may be matched to applicable requirements and sorted in order of relevance of the requirements of each feature, which would allow for prioritization of compliance requirements (e.g., system, security, ethical, business, legal, financial, etc.). Recommendation engine 306 may receive the answers from Q&A system 302 and determine product behaviors to identify recommendations to a user or any other party who desires to offer the product through an entity's operations. The recommendations may include requirements such as rules and recommended or suggested actions based on an observation of the answers from Q&A system 302. Recommendations may be sorted in order of relevance to a given rule or standard, which may allow for prioritization of compliance requirements.

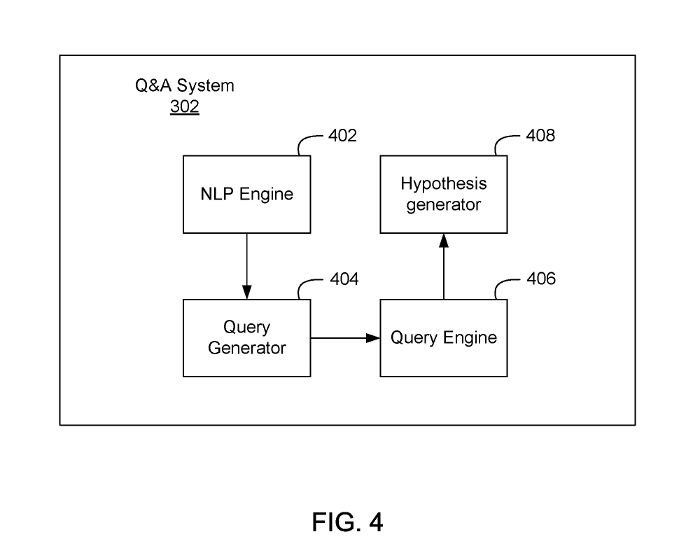

FIG. 4 presents a logic flow diagram of a Q&A system according to an embodiment of the present invention. Q&A system 302 includes NLP engine 402, query generator 404, query engine 406, and hypothesis generator 408. NLP engine 402 may be configured to parse features from product source 308 by using NLP to analyze text, numbers, characters, etc., and form a natural language understanding of a product. The NLP engine 402 is able to forward the features to query generator 404 for converting the features into one or more queries. Query generator 404 may express one or more queries by, for example, question type (e.g., who, what, when, where, and how), answer type (e.g., also who, what, when, where, and how), and keywords, from the features. The query generator 404 may use, for example, relational algebra to break the features into one or more queries suitable for instructing query engine 406 to execute information retrieval from a corpus of evidence data (e.g., including a collection of reference texts, internal organization documents and web pages, newswire reports, and online publications, etc. that define specific rules, regulations, or obligations, and actions that are required for compliance with the rules, regulations, or obligations) and/or a knowledge representation.

According to one embodiment, the features may be converted into relational queries. A relational query may include either procedural or non-procedural language. Procedural query language may comprise a set of queries instructing the query engine 406 to perform various transactions in a sequence (e.g., what to retrieve and how to retrieve). Non-procedural queries may comprise a single query directed to one or more tables to get a result from a database (e.g., what to retrieve from a database).

Query engine 406 is able to receive the queries from query generator 404 and use the queries to retrieve evidence data from the corpus of evidence data, for example, rules and corresponding actions from rules and actions databases 310 that match queries from query generator 404. The query engine 406 can generate instructions for fetching or reading information from databases (e.g., rules and actions databases 310) using the queries from query generator 404. Query engine 406 may analyze the queries to identify query elements, for example, keywords, question type, and answer type. Using the query elements, the query engine 406 may extract evidence data from one or more files or records from the corpus of evidence data. In some embodiments, the query engine 406 may perform a search by counting occurrences of query keywords. Alternatively, the query engine 406 may be trained to fetch “learned” responses to certain queries by using a knowledge representation.

According to another embodiment, the query engine 406 may transform queries into evidence extraction patterns. For example, a query may be transformed into evidence forms by rearranging the verb through each position of the query and specifying which side of the verb should be searched for an answer to the query according to the following:

Question: What standards are required for securing electronic financial transactions?

Transformations:

1. [standards are required for securing electronic financial transactions, L],

2. [standards required are for securing electronic financial transactions, L],

3. [standards required for are securing electronic financial transactions, E],

4. [standards required for securing are electronic financial transactions, R],

5. [standards required for securing electronic are financial transactions, R],

6. [standards required for securing electronic financial are transactions, R],

7. [standards required for securing electronic financial transactions are, R].

One or more of the query-to-answer transformations may be used to match and retrieve evidence.

Query engine 406 may include an interface to one or more databases. According to one embodiment, the query engine 406 may request evidence data from databases by communicating with a database management system (DBMS). The DBMS may comprise system software for creating and managing databases. A DBMS is able to serve as an interface between a database and end users or application programs to ensure that data is consistently organized and remains easily accessible.

The query engine 406 may forward the evidence data to hypothesis generator 408. Hypothesis generator 408 may construct answers to the queries using the evidence data. Based on the application of the queries to the corpus of evidence data, a set of hypotheses, or candidate answers to the queries, may be generated by examining the evidence data for containing a relevant answer to the queries. Hypothesis generator 408 may analyze a wide range of possible answers for the queries, and for each answer, an evidence score may be developed by gathering, analyzing and assessing evidence data. In one embodiment, the hypothesis generator 408 may calculate an evidence score based on, for example, the frequency with which a word occurs in a piece of evidence (e.g., by the frequency and weight analyzer) and any associated weighting of the occurred word inside the evidence. According to another embodiment, the evidence may be ranked according to n-gram matching with the queries. In yet another embodiment, queries may be transformed into evidence extraction patterns and matched with the evidence.

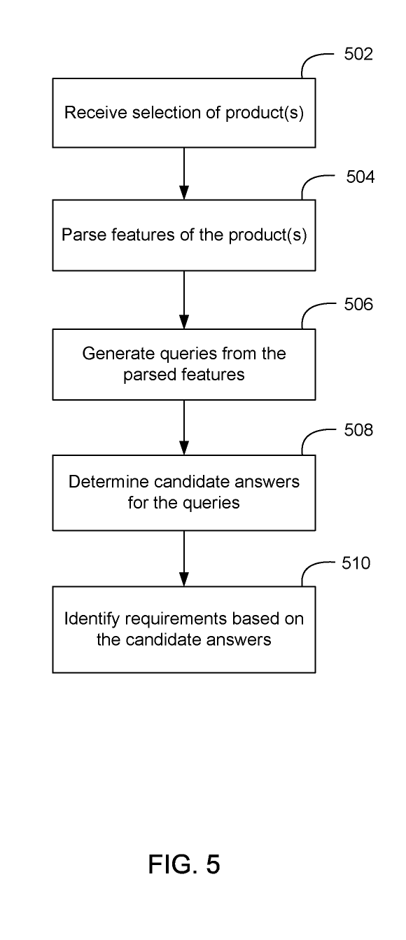

FIG. 5 presents a flowchart of a method for retrieving information using a knowledge representation according to an embodiment of the present invention. A selection of one or more products is received, step 502. The products may comprise e.g., software, policies, contracts, transactions (e.g., financial), computing services (e.g., storage, cloud computing, networking), and consulting services that the entity desires to offer via its operations (assets, investments, holdings, obligations, provided services, functions, contracts, third-party services, security, technology, or processes). A Q&A system may retrieve details of the one or more products from a product data input. In one embodiment, said product data input comprises an upload or export of data associated with said one or more products from at least one of data files, source code, and product documentation.

Features of the one or more products are parsed by the Q&A system from the product data input, step 504. In one illustrative embodiment, the mechanisms of the illustrative embodiments include a Q&A system that has been trained (e.g., to create a knowledge representation) with a corpus comprising one or more user manuals, source code, data files, product documentations (design documents, instructions, warranty, prospectus, brochures, marketing, diagrams, tables, and charts), publications, encyclopedias, dictionaries, thesauri, newswire articles, literary works, and other documentation corresponding to various types of products for which queries may be submitted to the Q&A system. Parsing features from the product data input may include extracting words, numbers, characters, etc., from source code, specific files, filenames, metadata, or content from the product data. Feature parsing may also include the Q&A system using Q&A technologies to analyze and derive meaning from the extracted words, numbers, characters, etc. According to one embodiment, certain words or strings of characters may be assigned to one or more tags identifying particular features and are stored in a dictionary. For example, the words “hedge,” “collateral,” and “leverage” may indicate particular features of a financial product that are associated with certain operational requirements, risks, and obligations. In another embodiment, the certain words or strings of characters may be used to train a classifier via machine learning (e.g., using machine learning techniques such as neural networks) to help identify product features.

Queries are generated from the parsed features, step 506. Concepts or topics can be determined from the parsing of the product data input using the Q&A technologies. The identified concepts or topics can be expressed as one or more queries by, for example, word fragments including keywords from the features. Candidate answers are determined for the queries, step 508. The Q&A system may construct candidate answers by querying a corpus of evidence data (and/or knowledge representation) that includes rules, compliances, regulations, or obligations may be associated with aspects of system (hardware and/or software) capabilities, security standards, ethical (e.g., social media) standards, corporate governance, legal liabilities, and financial standards, etc. The corpus of evidence data may include a structured database and/or an unstructured collection of reference texts, internal organization documents and web pages, newswire reports, and online publications, etc. The Q&A system may perform analysis and comparison of the language of the queries and the language used in each of the portions of the corpus of evidence data found during the application of the queries. The Q&A system may take the queries, analyze them, decompose the queries into constituent parts, and generate one or more candidate answers by using the decomposed queries to search a corpus of evidence data.

Requirements are identified based on the candidate answers, step 510. The candidate answers may be representative of requirements (e.g., rules and actions) based on the features of the one or more products. The features of the one or more products may also be ranked based on the relevance to the candidate answers. Ranking the features of the one or more products may include scoring candidate answers based on a retrieval of evidence from evidence sources, performing synthesis of the scoring of the candidate answers, and based on trained models, performing a final merging and ranking to output an answer to a given query along with a confidence score. Candidate answer scoring may be used to evaluate the likelihood that the particular candidate answer is a correct answer for the query. This may include using a plurality of reasoning algorithms, for example, each performing a separate type of analysis of the language of the queries and/or content of the corpus that provides evidence in support of, or not, of the candidate answers. Some reasoning algorithms may look at the matching of terms and synonyms within the language of the query and the found portions of the corpus of evidence data. Other reasoning algorithms may look at temporal or spatial features in the language, while others may evaluate the source of the portion of the corpus of evidence data and evaluate its veracity. Each reasoning algorithm may generate an evidence score based on the analysis it performs which indicates a measure of relevance of the individual portions of the corpus of data/information extracted by application of the queries as well as a measure of the correctness of the corresponding candidate answers, e.g., a measure of confidence in the candidate answers.

Evidence scores generated by the various reasoning algorithms may be synthesized into a confidence score for each of the various candidate answers. Such a process may involve applying weights to the various evidence scores, where the weights can be determined through training of a statistical model employed by the Q&A system. Specifically, the weighted scores may be processed in accordance with a statistical model generated through training of the Q&A system that identifies a manner by which these scores may be combined to generate a confidence score for the individual candidate answers. A confidence score may be representative of a level of confidence that the Q&A system has about whether a candidate answer is a correct answer for a given query. The evidence scores can be processed by a final merging and ranking stage which may compare the evidence scores, compare them against predetermined thresholds, or perform any other analysis on the evidence scores to determine which candidate answers are the most likely to be the answer to the query. The candidate answers may be ranked according to these comparisons to generate a ranked listing of candidate answers. From the ranked listing of candidate answers, a final answer and confidence score, or final set of candidate answers and confidence scores, may be generated and outputted. Features associated with answers having the best matching answers may be ranked higher. The set of candidate answers, requirements, and ranking can be rendered and outputted via a graphical user interface rendered by a computing device.

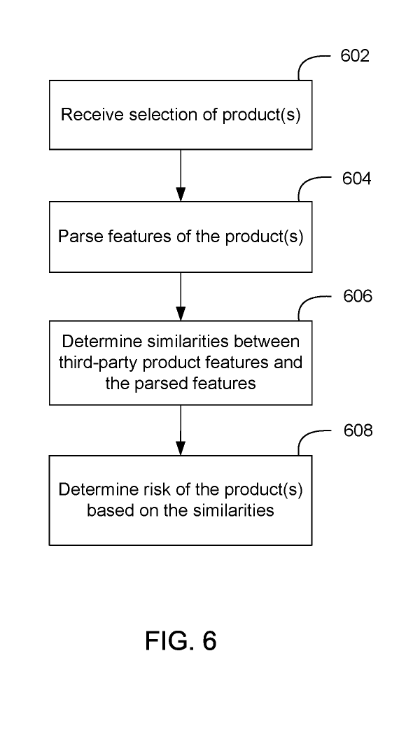

FIG. 6 presents a flowchart of a method for retrieving information using a knowledge representation according to another embodiment of the present invention. A selection of one or more products is received, step 602. A Q&A system may retrieve details of the one or more products from a product data input. Features of the one or more products are parsed by the Q&A system from the product data input, step 604. In one illustrative embodiment, the mechanisms of the illustrative embodiments include a Q&A system that has been trained with a corpus comprising one or more user manuals, source code, data files, product documentations (design documents, instructions, warranty, prospectus, brochures, marketing, diagrams, tables, and charts), publications, encyclopedias, dictionaries, thesauri, newswire articles, literary works, and other documentation corresponding to various types of products such as third-party products, for which queries may be submitted to the Q&A system.

Parsing features from the product data input may include extracting words, numbers, characters, etc., from source code, specific files, filenames, metadata, or content from the product data. Feature parsing may also include the usage of a Q&A system or Q&A technologies to analyze and derive meaning from the extracted words, numbers, characters, etc. According to one embodiment, certain words or strings of characters may be assigned to one or more tags identifying particular features and are stored in a dictionary. For example, the words “hedge,” “collateral,” and “leverage” may indicate particular features of a financial product that are associated with certain operational requirements, risks, and obligations. In another embodiment, the certain words or strings of characters may be used to train a classifier via machine learning (e.g., using machine learning techniques such as neural networks) to help identify product features.

Similarities between third-party product features and the parsed features are determined, step 606. The Q&A system may evaluate products from third-parties that have features that are similar to the selected product. Features of the third-party products may be evaluated based on industry, type, function, requirements, etc. Concepts or topics can be determined from the parsing of the product data input. The identified concepts or topics can be used to build one or more queries. The Q&A system may query a corpus and/or knowledge representation of the third-party product features using the one or more queries and construct candidate answers for the one or more queries. The Q&A system may take the queries, analyze them, decompose the queries into constituent parts, and generate one or more candidate answers based on the queries and results of a search of the corpus and/or knowledge representation of third-party features.

Risk of the one or more products is determined based on the similarity, step 608. A score of, for example, potential compliance risks may be calculated based on the one or more products having features that are similar to features of third-party products. The risk may be determined based on an aggregate risk of individual third-party product features that are similar to the one or more products. Alternatively, the risk may be determined based on predetermined risk scores assigned to third-party products including the third-party product features that that similar to the parsed features. The risk of the one or more products may be rendered and outputted via a graphical user interface rendered by a computing device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor, a memory and an artificial intelligence unit, for retrieving information using a knowledge representation, the method comprising:
receiving, by the data processing system, a selection of a product from a computing device;
parsing, by the data processing system, features of the product from product data input;
generating, by the data processing system, queries from the parsed features;
determining, by the data processing system, candidate answers for the queries;
identifying, by the data processing system, requirements for the product based on the candidate answers; and
providing, by the data processing system, the requirements to the computing device.

2. The method of claim 1 further comprising ranking, by the data processing system, the parsed features based on a relevance of the parsed features to the candidate answers

3. The method of claim 2 wherein ranking the features of the product further comprises:
assigning, by the data processing system, evidence scores to the candidate answers;
synthesizing, by the data processing system, the evidence scores; and
calculating, by the data processing system, a confidence score of the candidate answers based on the synthesized scores.

4. The method of claim 3 wherein assigning the evidence scores to the candidate answers further comprises determining relevance of the candidate answers by analyzing language of the queries and a corpus of evidence data.

5. The method of claim 3 further comprising applying weights to the evidence scores based on training of the data processing system with a statistical model, the weights identifying a manner to combine the evidence score to calculate the confidence score.

6. The method of claim 1 wherein the one or more products is selected from a group consisting of: software, policies, contracts, transactions, computing services, and consulting services.

7. The method of claim 1 further comprising training the data processing system with a corpus of documents corresponding to various types of products.

8. The method of claim 1 further comprising training the data processing system with words that are useful in identifying features of the product.

9. The method of claim 1 wherein the artificial intelligence unit comprises a combination of natural language processing, semantic analysis, information retrieval, knowledge representation, automated reasoning, and machine learning technologies.

10. The method of claim 1 wherein parsing features of the product further comprises extracting words, numbers, and characters from source code, specific files, filenames, metadata, or content from the product data input.

11. The method of claim 1 wherein generating the queries from the parsed features further comprises expressing, by the data processing system, the parsed features as word fragments including keywords.

12. The method of claim 1 wherein determining candidate answers for the queries further comprises:
querying, by the data processing system, a corpus of evidence data, wherein the corpus of evidence data includes information associated with system capabilities, security standards, ethical standards, corporate governance, legal liabilities, and financial standards; and
constructing, by the data processing system, the candidate answers based on the querying of the corpus of evidence data.

13. The method of claim 1 further comprising:
analyzing, by the data processing system, the queries;
decomposing, by the data processing system, the queries into constituent parts; and
querying, by the data processing system, a corpus of evidence data using the decomposed queries; and
generating, by the data processing system, the candidate answers based on the querying of the corpus of evidence data.

14. The method of claim 1 wherein the requirements include rules or actions selected from the group consisting of operating directives, guidelines, parameters, instructions, control information, benchmarks, models, system requirements, capital requirements, personnel requirements, and specifications that are associated with the parsed features.

15. A computing system for retrieving information using a knowledge representation, the computing system comprising a computer processor including an artificial intelligence unit and a computer memory operatively coupled to the computer processor, the computer memory having disposed within it computer program instructions that, when executed by the processor, cause the computing system to carry out the steps of:
receiving a selection of a product from a computing device;
parsing features of the product from product data input;
generating queries from the parsed features;
determining candidate answers for the queries;
identifying requirements for the product based on the candidate answers; and
providing the requirements to the computing device.

16. A computer program product for comparing features using a knowledge representation of third-party products, the computer program product comprising:
a computer readable storage medium having stored thereon:
program instructions executable by a processing device to cause the processing device to receive a selection of a product;
program instructions executable by the processing device to cause the processing device to parse features of the product from product data input;
program instructions executable by the processing device to cause the processing device to determine similarities between features of third-party products within the knowledge representation and the parsed features; and
program instructions executable by the processing device to cause the processing device to determine risk of the product based on the similarities.

17. The computer program product of claim 16 further comprising:
program instructions executable by the processing device to cause the processing device to generate one or more queries from the parsed features;
program instructions executable by the processing device to cause the processing device to query a corpus of the features of the third-party products using the one or more queries; and
program instructions executable by the processing device to cause the processing device to construct candidate answers based on the querying of the corpus of the features of the third-party product features.

18. The computer program product of claim 16 further comprising program instructions executable by the processing device to cause the processing device to calculate a score for the risk of the product based on the similarities between the third-party product features and the parsed features.

19. The computer program product of claim 16 further comprising program instructions executable by the processing device to cause the processing device to determine the risk based on an aggregate risk of individual third-party product features that are similar to the product.

20. The computer program product of claim 16 further comprising program instructions executable by the processing device to cause the processing device to determine the risk based on risk scores of the third-party products.
